(19) United States
(12) Patent Application Publication
(10) Pub. No.: US 2012/0052469 A1
(43) Pub. Date: Mar. 1, 2012

(54) NASAL FLOW DEVICE CONTROLLER

(75) Inventors: Noam Sobel, Jaffa (IL); Aharon Weissbrod, Rehovot (IL); Lee Sela, Rehovot (IL); Anton Plotkin, Rehovot (IL)

(73) Assignee: Yeda Research And Development Co. Ltd. at the Weizmann Institute of Sience, Rehovot (IL)

(21) Appl. No.: 13/265,891

(22) PCT Filed: Apr. 22, 2010
(86) PCT No.: PCT/IL10/00326

§ 371 Date: Oct. 24, 2011

Related U.S. Application Data
(60) Provisional application No. 61/202,959, filed on Apr. 23, 2009.

(51) Int. Cl. G09B 23/28

(52) U.S. Cl. 434/262

(57) ABSTRACT

A method of receiving input from a user, comprising measuring a nasal air parameter and generating an instruction for one or both of a device and controller based on said measurement.

### RELATED APPLICATION/S

This application claims the benefit under 35 USC 119(e) of U.S. Provisional Patent Application No. 61/202,959 filed Apr. 23, 2009.

### FIELD OF THE INVENTION

The present invention, in some embodiments thereof, relates to a device controller that receives input from a nasal sensor and, more particularly, but not exclusively, to a device controller which is controlled by sniff parameters.

### BACKGROUND OF THE INVENTION

Modern life takes advantage of the abilities of communication and controlling of devices. However, the ability to communicate, and more so, the ability to control devices, are at times lost. Communication depends on control of speech, which is sometimes lost to disease or injury. Alternative avenues to communication such as typing are at times also lost due to conditions such as complete paralysis. Similarly, control over devices unrelated to communication, such as a vehicle, may also be lost due to injury or paralysis.

Whereas a loss of the ability to control devices forms a major hardship in life, the loss of the ability to communicate is simply devastating. The prototype example of this state is “locked in syndrome” (LIS) (e.g. Laureys S, Pellas F, Van Eeckhout P, Ghorbel S, Schnakers C, Perrin F, Berre J, Faymonville M E, Pantke K H, Damas F, Lamy M, Moonen G, Goldman S (2005) The locked-in syndrome: what is it like to be conscious but paralyzed and voiceless? Prog Brain Res 150:495-511). LIS can result from injury such as stroke or from progression of neurodegenerative diseases such as ALS. LIS patients can often self-respirate, and maintain gaze control. More severe cases, however, termed “complete locked in syndrome (CLIS), lose self respiration and gaze as well. These patients are thought to be completely cognizant of their surroundings and condition, yet also completely unable to communicate.

Modern technology has provided several alternative solutions to the loss of communication and control. For example:

Paralyzed or amputated individuals can communicate and control devices through eye-movements (e.g. LaCourse, J. R., Hludik, F. C. (1990), An Eye Movement Communication—Control System for the Disabled. IEEE Transactions on Biomedical Engineering. Volume 31, Number 12, Pages 1215-1220). The advantage of gaze-control is that gaze is one of the best-preserved faculties. In other words, individuals who have lost control over most all of their body, may still be able to volitionally direct their gaze. An alternative means of communication and control is through recorded and transduced brain activity. Recording electrodes can be pasted on the scalp (e.g. Kiiblera, A., and Birbaumer, N. (2008), Brain-computer interfaces and communication in paralysis: Extinction of goal directed thinking in completely paralysed patients? Clinical Neurophysiology. Volume 119, Issue 11, Pages 2658-2666.), or surgically placed in the brain (e.g. Hinterbergera, T., Widmanc, G., Lald, T. N., Hilld, J., Tangermanne, M., Rosenstielf, W., Schölkopfd, B., Elgerc, C., and Birbaumerb, N. (2008). Voluntary brain regulation and communication with electrocorticogram signals. Epilepsy & Behavior. Volume 13, Issue 2, Pages 300-306). The recorded neural activity can then be used to control devices ranging from communication apparatus such as a computer to electric wheelchairs.

Another approach is to use an apparatus where a disabled person can communicate and control devices by a ‘sip-puff’ akin to using a straw, as disclosed, for example, in Fugger, E., Asslaber, M. & Hochgatterer, A. Mouth-controlled interface for Human-Machine Interaction in education & training. Assistive technology: added value to the quality of life, AAATE'01, 379 (2001), hereinafter ‘Fugger et al. 2001’.

Additional background art includes:
Birbaumer N, Murguialday A R, Cohen L. Brain-computer interface in paralysis. Curr Opin Neurol. 2008 December; 21(6):634-8. Review.
Johnson B N, Mainland J D, Sobel N. Rapid olfactory processing implicates subcortical control of an olfactomotor system. J. Neurophysiol. 2003 August; 90(2):1084-94, hereinafter ‘Johnson et al., 2003’.
Kübler A, Furdea A, Halder S, Hammer E M, Nijboer F, Kotchoubey B. A brain-computer interface controlled auditory event-related potential (p300) spelling system for locked-in patients. Ann N Y Acad Sci. 2009 March; 1157:90-100.
Laureys S, Pellas F, Van Eeckhout P, Ghorbel S, Schnakers C, Perrin F, Berré J, Faymonville M E, Pantke K H, Damas F, Lamy M, Moonen G, Goldman S. The locked-in syndrome: what is it like to be conscious but paralyzed and voiceless? Prog Brain Res. 2005; 150:495-511.
Roberts, A. Pruehsner, W. Enderle, J. D. Vocal, motorized, and environmentally controlled chair. Bioengineering Conference, 1999. Proceedings of the IEEE 25th Annual Northeast. 8-9 Apr. 1999.
Sobel N, Prabhakaran V, Desmond J E, Glover G H, Goode R L, Sullivan E V, Gabrieli J D. Sniffing and smelling: separate subsystems in the human olfactory cortex. Nature. 1998 Mar. 19; 392(6673):282-6, hereinafter ‘Sobel et al., 1998’.
Plotkin A., Sela L., Weissbrod A., Sobel N., and Soroker N., A brain-machine interface through the nose, The Israel Association of Physical & Rehabilitation Medicine, Nov. 18-19, 2009.
Plotkin A., Sela L., Weissbrod A., Soroker N., and Sobel N., A brain-machine interface through the nose, Israel Society for Neuroscience 18th Annual Meeting, Nov. 23, 2009.

### SUMMARY OF THE INVENTION

In accordance with exemplary embodiments of the invention, nasal air flow, as modified by, e.g., conscious or unconscious control, is used as an input means, for example, to control mechanical devices or software. Optionally, the input is nostril dependent. In an exemplary embodiment of the invention, the control is used for receiving input from paralyzed or other handicapped users. Optionally or alternatively, the control is used for controlling devices in situations where other input methods are already in use (e.g., a pilot) or unavailable (e.g., in a spacesuit).

There is provided in accordance with an exemplary embodiment of the invention, a method of receiving input from a user, comprising:

(a) measuring a nasal air parameter; and

(b) generating an instruction for one or both of a device and controller based on said measurement.

Optionally, said measuring comprises measuring two independent parameters of said nasal air and generating an instruction therefrom.

Optionally, said measuring comprises measuring at least two independent parameters of said nasal air, and generating an instruction therefrom.

Optionally, said measuring comprises measuring at least three independent parameters of said nasal air, and generating an instruction therefrom.

Optionally, said measuring comprises measuring at least one analogue parameter, and generating an instruction therefrom.

Optionally, said measuring comprises measuring at least one of air direction, air flow duration, air flow rate or sound frequency, and generating an instruction therefrom.

Optionally, said measuring comprises measuring any combination of air direction, air flow duration and air flow rate, or sound frequency, and generating an instruction therefrom.

In some embodiments, said generating comprises generating responsive to duty cycle of air flow parameter.

In some embodiments, said generating comprises generating a vector representative of the command.

In an exemplary embodiment of the invention, said generating comprises generating using a table. Optionally or alternatively, said generating comprises generating using from a series of measured parameter values.

In some embodiments, generating an instruction for one or both of a device and controller comprises providing a feedback for the instruction from the one or both of a device and controller.

In an exemplary embodiment of the invention, said measuring comprises measuring form two nostrils.

In an exemplary embodiment of the invention, the method comprises training a user in selectively directing airflow to the nasal area.

Optionally, said user is paralyzed in at least four limbs. Optionally, said user is artificially respirated.

In an exemplary embodiment of the invention, said user is not handicapped.

In exemplary embodiments of the invention, receiving input from a user comprises deciding an operation for one or both of a device and controller, expressing the decision by at least one nasal sniff and generating an instruction for the one or both of a device and controller based on measuring the sniff.

There is provided in accordance with an exemplary embodiment of the invention a method of receiving input from a user, comprising:

(a) deciding an operation for one or both of a device and controller;

(b) expressing the decision by at least one nasal sniff; and

(c) generating an instruction for the one or both of a device and controller based on the sniff.

In some embodiments, expressing the decision by at least one nasal sniff comprises expressing the decision in a sequence of a plurality of sniffs.

There is provided in accordance with an exemplary embodiment of the invention apparatus for control, comprising:

(a) a sensor configured to measure a nasal air parameter; and

(b) circuitry which converts said measurement into a command for one or both of a device and a controller.

Optionally, the apparatus comprises a sensor for each nostril. Optionally or alternatively, said circuitry differentiates inwards sniffing from outwards sniffing.

Optionally or alternatively, said circuitry ignores natural breathing.

In some embodiments, said device comprises a device controlled electrically or electronically or programmatically or by any combination thereof.

Optionally, said device comprises a device having one or both of analogue or discrete control.

Optionally, said device comprises a pointing device on a computer driven display.

In an exemplary embodiment of the invention, said device comprises a wheelchair. Optionally or alternatively, said controller comprises a communication device.

There is provided in accordance with an exemplary embodiment of the invention a method of receiving input from a subject, comprising:

(a) assessing the position of the soft palate of the subject; and

(b) generating an instruction for one or both of a device and controller based on the assessment of the position of the soft palate.

In some embodiments, the assessment is responsive to a reflection of a sound wave transmitted towards the soft palate.

In some embodiments, the assessment is responsive to magnetic field of a magnet attached to the soft palate.

In some embodiments, the assessment is responsive to a neural activity acquired by an electrode.

In some embodiments, assessing the position of the soft palate is responsive to sniffing by the subject.

In some embodiments, the subject is artificially respirated.

There is provided in accordance with an exemplary embodiment of the invention an apparatus configured to carry out the method described above.

There is provided in accordance with an exemplary embodiment of the invention a method for training a subject to switch between a nasal and oral breathing without mouth closure, comprising:

(a) providing an air passage to the nose and an air passage to the mouth of the subject;

(b) measuring the air flow in said passages responsive to prompting the subject to breath orally or nasally; and

(c) providing the subject with a feedback on the success of switching between a nasal and oral breathing.

In some embodiments, the success of switching is presented graphically, enabling the subject to interactively adjust the switching.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic showing of a nasal input system mounted on a human user, in accordance with an exemplary embodiment of the invention;

FIGS. 2A-2D illustrate various nasal input sensors in accordance with exemplary embodiments of the invention;

FIG. 3 is a circuit diagram for a nasal sensor in accordance with an exemplary embodiment of the invention;

FIG. 4 is a flowchart of a method of sensing nasal air parameters, in accordance with exemplary embodiments of the invention;

FIG. 5 schematically illustrates an amplitude modulation of sniffing, in accordance with exemplary embodiments of the invention;

FIG. 6 schematically illustrates a sniffing duty cycle, in accordance with exemplary embodiments of the invention;

FIG. 7 schematically illustrates pumped respiration with a nasal mask, in accordance with exemplary embodiments of the invention;

FIG. 8 illustrates an fMRI scan of brain activation during volitional control of the soft palate by a subject, in mid-sagital, coronal and transverse sections;

FIG. 9A schematically illustrates experimental reaction time to an interactive stimulus with respect to training time with a mouse, joystick and sniff controller, in accordance with exemplary embodiments of the invention;

FIG. 9B schematically illustrates a summary of experimental reaction times to an interactive stimulus before and after training of a mouse, joystick and sniff controller, in accordance with exemplary embodiments with the invention;

FIG. 10A schematically illustrates experimental results of accuracy of tracking a guide pattern with a mouse, joystick and sniff controller, in accordance with exemplary embodiments of the invention; and

FIG. 10B schematically illustrates a summary of experimental accuracies of tracking a guide pattern with a mouse, joystick and sniff controller, in accordance with exemplary embodiments of the invention.

### DESCRIPTION OF EMBODIMENTS OF THE INVENTION

The present invention, in some embodiments thereof, relates to a device controller that receives input from a nasal sensor and, more particularly, but not exclusively, to a device controller which is controlled by sniff parameters.

An aspect of some embodiments of the invention relates to measuring nasal air, for example, air-flow, for example, sniff, parameters and using the parameters as an input to a computer and/or for controlling a device. In an exemplary embodiment of the invention, the device is controlled in real-time, for example, the device being able to respond to a “command” from the nasal input before a next command is received, or in near-real time, for example, a few seconds. Other suitable time frames for response include, for example, 50 ms, 100 ms, 400 ms, 800 ms, 1 second, 2 seconds, 5 seconds or intermediate or longer times. Optionally or alternatively to input into a computer or for controlling a device, the nasal input is logged and later analyzed. In an exemplary embodiment of the invention, the controlled device or computer provides feedback to the user. Alternatively, no feedback is provided to the user. In an exemplary embodiment of the invention, the feedback is nasal, for example comprising airflow or odors into the nasal area.

In an exemplary embodiment of the invention, the nasal measurement is independent of oral measurement. Optionally or alternatively, the user is trained to independently control nasal flow.

In an exemplary embodiment of the invention, the user is a human, for example, paralyzed or whose hands are otherwise occupied. In other embodiments, the user is an animal, such as a dog, dolphin or rat. It is noted that the terms ‘user’ and ‘subject’ are used herein interchangeably.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Overview

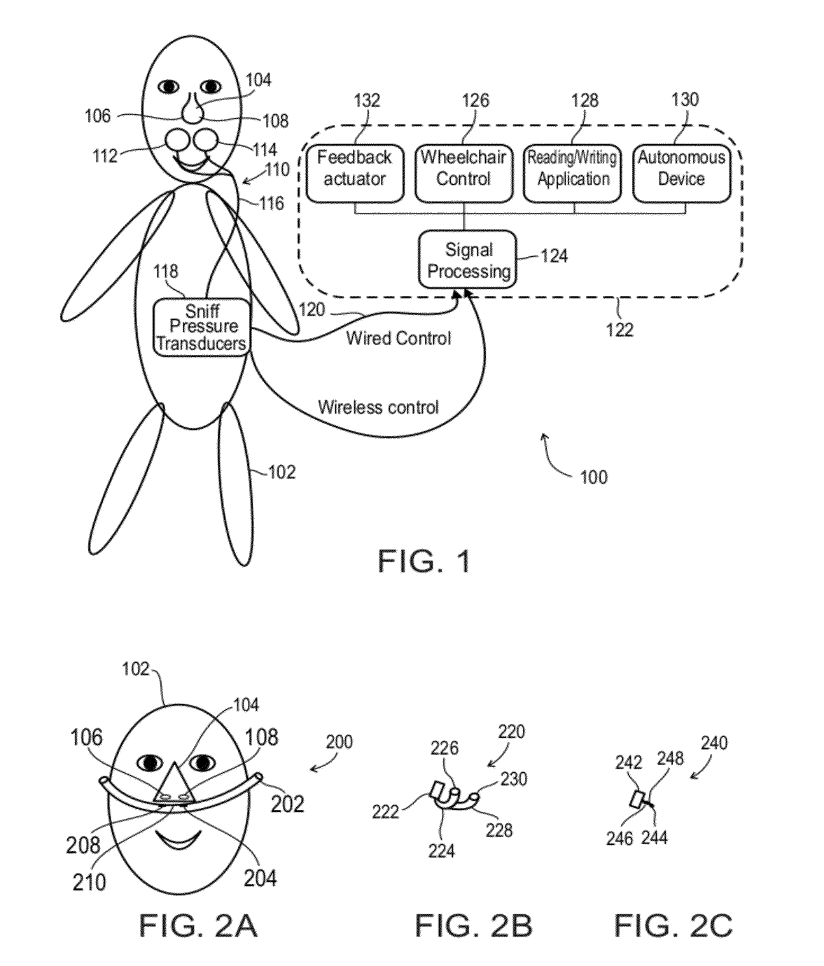

Referring now to the drawings, FIG. 1 is a schematic showing of a nasal input system 100 mounted on a human user 102, in accordance with an exemplary embodiment of the invention. As shown, human 102 has a nose 104 with a left nostril 106 and a right nostril 108. Parameters of the air at the nostrils are measured using a measurement system 110 and used as an input to a computer or circuitry 122.

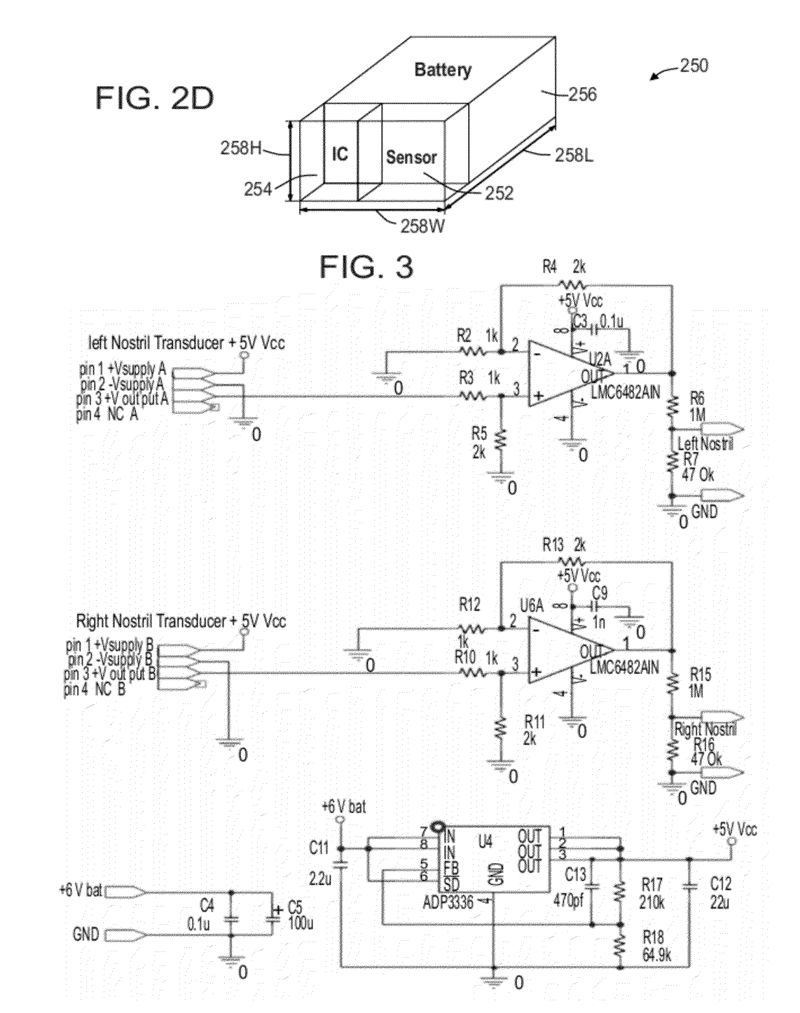

In the particular embodiment shown, a left nostrils sensor 112 and a right nostril sensor 114 are shown. Optionally, only one sensor is used, in one nostril, or shared. In the example shown, the sensors are not at the nostrils, but rather a tube with holes (see FIG. 2A) is provided at the nostrils and conveys pressure changes caused by sniffing via a tube or tubes 116 to a circuitry box 118, optionally battery powered, which includes pressure and/or airflow transducers. In an exemplary embodiment of the invention, the transducer is a pressure transducer, by All Sensor (USA) 1INCH-D-4-V, which attaches to the sets of 4 pins on the left side of FIG. 3.

A wire 120 or wireless means, such as a radio link, such as Bluetooth, is used to convey the measurements to circuitry 122. Optionally, the signals are processed by a processor 124, for example, an NI sbRIO-9611, and one or more commands are extracted. Optionally, the commands are sent as data input to a computer program, such as a reading/writing application 128. Optionally or alternatively, the command is sent to a wheelchair controller 126. Optionally or alternatively, the command is sent to an autonomous device, such as a data logger or a vital signs monitor of whose operation the user is not aware. Optionally or alternatively, the commands are sent to one or more other devices, which may be connected, for example, simultaneously, or selectively.

As sniffing is based on nasal breathing, after a plurality of sniffs in some typical cases a subject needs to breath without sniffing (nasally and/or orally) to recover breathing and/or to take a deep breath (sigh). Accordingly, in some embodiments, a device under sniff control is configured to expect delays in sniffing, optionally suspending control thereby letting the subject to breath.

In some embodiments, the delay is preset according to the subject (e.g. child or adult). In some embodiments, the delay is determined, at least to some extent, based on past breathing pattern or patterns. In some embodiments, the device stops receiving sniff control when a breath is expected or deemed to be needed, optionally indicating to the subject that acceptance of sniff control is suspended for breathing.

In an exemplary embodiment of the invention, the user is provided with feedback, for example, via a feedback actuator 132. Optionally, the various devices provide feedback on their own, for example, via sounds or visual display. Optionally or alternatively, the feedback actuator provides direct feedback, for example of the command or for the device. Optionally, the feedback is nasal oriented, for example, including being a puff of air into or near a nostril, release of one or more scents (e.g., by heating a cell on an array of scent imbued or covered electrodes) and/or electrical stimulation of olfactory or other tissue near the nostril. Optionally, the feedback is discrete. Alternatively, the feedback may include a continuous signal and/or an analog signal (e.g., amplitude and/or duration encoded).

In some embodiments, the feedback indicates the progress and/or execution of an instruction by a device under a sniff control. Optionally or additionally, the feedback indicates that the device received the sniff control and that the command was interpreted correctly or incorrectly or was not interpretable (e.g. akin to Ack/Nack in communications).

In the embodiment shown, three components, a nasal sensor, a measurement device and separate circuitry. In other embodiments, the functions of the system are divided otherwise. For example, a single unit can include nasal measurement, initial processing and command generation and sending by means readable by controlled device (e.g., Bluetooth). In another example, box 118 is integrated with sensors 112 and 114. In another example, system 100 is integrated into a controlled device, such as a wheel chair and/or provides functions other than nasal input and/or output.

### Exemplary Nasal Elements

FIG. 2A-2D illustrate various nasal input sensors in accordance with exemplary embodiments of the invention.

FIG. 2A shows a tube based sensor 200, in which a tube 202 runs from ear to ear of the user and includes one or more apertures 208, 204 adjacent the nostrils. When sniffing, the apertures and tube convey pressure changes caused by sniffing to a pressure transducer (not shown, 118). Optionally, the nostrils are measured separately, as shown by a block 210 blocking flow between apertures 204 and 208 inside tube 202. Optionally, apertures 204, 208 include short tube sections (not shown) that reach into the nostrils.

In some embodiments, the subject can scrunch and/or twist the face and/or nose to selectively control the sniffing of each nostril, optionally sniffing through a selected single nostril.

The tube support (not shown) can be, for example, as used for oxygen delivery systems. Optionally, oxygen is delivered via tube 202 or via a second tube (not shown).

FIG. 3 is a circuit diagram for electronics for left and right nostril sensors, (top two) a power supply (bottom right) and a noise reduction circuit (bottom left), in accordance with an exemplary embodiment of the invention. In an exemplary embodiment of the invention, the gain of the amplifiers of the left and right nostril sensors is reduced, for example, to reduce saturation, this can be done, for example, by setting R4, R5, R13 and R11 to 1K, from 2K.

FIG. 2B shows a nostril mounted sensor 220, including an integral sensing circuitry (inside a housing 222, for example) and a tube 224 with an aperture 226 to carry air properties to circuitry (e.g., a pressure sensor) in housing 222. Optionally, housing 222 includes a wired or wireless transmitter and/or processing circuitry. Optionally, housing 222 includes a battery, for power.

Optionally or alternatively, an air sensor, such as a flowrate sensor or a pressure sensor is provided at the tip of tube 224 inside the nostril or near its opening. Optionally, tube 224 is replaced by a wire.

Optionally, a second tube or wire 228 with a sensor or an aperture 230 are provided for a second nostril and serviced by the same or different circuitry inside housing 222. Alternatively, a user may wear two mounted sensors 220.

In an exemplary embodiment of the invention, mounted sensor 220 is mounted using a clip. Optionally, the outer surface of the nostril is pinched between housing 222 and tube 224. Optionally, tube 224 includes a wire to make it plastically deformable yet resilient. Alternatively, tube 224 is elastic and optionally resilient. Optionally or alternatively, housing 222 includes a magnet which is attracted to a different part of mounted sensor 220, for example, tube 224.

Optionally or alternatively, housing 222 is adhesive to skin (e.g., includes an adhesive layer). Optionally or alternatively, housing 222 includes a suction attachment.

FIG. 2C shows an alternative mounted sensor design 240, which is mounted by transfixing through the nostril. In the embodiment shown, a housing 242 includes circuitry (e.g., as for sensor 220), and a wire 248 serves both to transfix the nostril and to hold a sensor 244 at its tip inside the nostril. Optionally, sensor 244 is electronic. Optionally, a clip 246 is used to maintain sensor 240 in place.

FIG. 2D schematically illustrates a compact housing design 250 for sensors such as 200, 220 or 240, according to exemplary embodiments of the invention. Housing design 250 comprises a sensor 252, an IC 254 (or other circuitry) and a battery 256 as power source. In some embodiments, IC 254 comprises an A/D converter, a microcontroller and/or a radio transceiver for wireless operation. In some embodiments, battery 256 is augmented and/or replaced by an energy harvesting apparatus using, for example, thermocouple or piezoelectric elements that convert body heat or motions into electricity. In some embodiments housing design 250 is used for wired connection with a computer instead of wireless connection, and in some embodiments IC 254 comprises or couples with computer interface such as USB that provides power instead of battery 256.

In some embodiments, without limiting, the dimensions of housing design 250 are about 8 mm by about 5 mm by about 3 mm, as indicated by arrows 258L, 258W and 258H, respectively. In some embodiments, the size of housing design 250 is smaller using devices of high components densities and/or when a more efficient battery technology is used.

In some embodiments, the mounted sensor generates a signal indicative of a difference in a parameter value between nostrils. Alternatively, only one nostril is measured. Alternatively, both nostrils are measured.

Optionally, any of sensors 200, 220 or 240 can include a feedback means, for example, a small vibrator contacting the nostril, an electrode contacting the nostril or an actuator that generates airflow into the nostril.

### Exemplary Modes of Operation

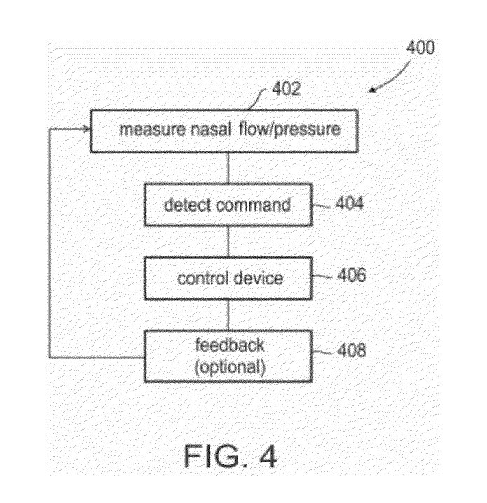

FIG. 4 is a flowchart 400 of a method of sensing nasal air parameters, in accordance with exemplary embodiments of the invention.

At 402, a nasal parameter is read in one or both nostrils. In an exemplary embodiment of the invention, the parameter is pressure. Optionally or alternatively, the parameter includes air flow rate (or magnitude) and/or direction. Optionally, two pressure sensors are used to sense a direction of air flow. Optionally or alternatively, a thermistor or humidity sensor is used (temperature and humidity are higher inside the body). Alternatively, a flowmeter, for example, based on heat generation and measurement, based on airflow cooling is used to estimate direction and/or rate of flow. Optionally or alternatively, two sensors are used to measure a gradient.

In some embodiments, thermal imaging (contactless) such as by IR camera and/or sensors are used to sense the sniffing by monitoring temperature variations during snuffing in or out.

In some cases, the air flow during sniffing-in cools a region about the nose such as the nostrils, and air flow during sniffing-out warms the cools a region about the nose such as the nostrils. Accordingly, in some embodiments, the thermal imager is directed towards the region about the nose to detect the temperature variations which are further processed to determine the sniffing.

In some embodiments the camera (or other thermal sensor) is disposed on the subject's face such as on the forehead or lip (e.g. under the nose) or by or on the nose. Optionally the camera (or sensor) is disposed on an article such as spectacles or an attachment to the ear (akin to earphone). In some embodiments the camera or sensor is disposed on a support such as a subject's wheelchair or bed.

In some embodiments a pad or patch is attached to the subject's nose or by the subject nose which responds sufficiently fast to the temperature variations and the camera senses the temperature of the pad or patch. In some embodiments the pad or patch is marked or otherwise formed so that the camera or sensor can track the pad as the patient head is moved. Optionally, the camera includes further elements that recognize the facial pattern of the subject and accordingly track the head movements to sense the temperature variations.

The signal acquired by the thermal camera or sensor is processed to extract or obtain the sniffing parameters such as sequences of sniffs with various durations and/or amplitudes and/or duration and/or directions.

As sniffing produce sound, in some embodiments a microphone is used to sense the sniffing, optionally within frequency regions below and/or above the typical human hearing zone such as ultrasound.

In some embodiments the microphone is disposed is disposed on the subject's face such as on the forehead or lip (e.g. under the nose) or by or on the nose or at a nostril. Optionally the microphone is disposed on an article such as spectacles or an attachment to the ear (akin to earphone) or a support such as the subject's bed. In some embodiments the microphone is specifically tuned for the sound frequency range of typical sniffing and/or the sound frequency range of a particular subject.

The signal acquired by the microphone is processed to extract or obtain the sniffing parameters such as sequences of sniffs with various durations and/or amplitudes and/or duration and/or directions.

As many individuals can train themselves to control the soft palate and produce sniffing by controllably manipulating the soft palate (see also below), in some embodiments the position of the soft palate is assessed (e.g. detected at least approximately) as a control parameter instead of and/or in addition to the sniffing.

In some embodiments, an ultrasound actuator (e.g. piezoelectric element) transmits a high-frequency acoustic wave in the direction of the soft palate and a correspondingly tuned microphone measures the reflected sound wave, thereby determining the position of the palate. For example, the ultrasound actuator is on the throat and transmits a narrow wave ('pencil beam') towards the palate in a particular direction and the microphone is positioned on the throat suitably to sense the reflected wave. Optionally the actuator is disposed, e.g. by pasting, in the upper portion of the mouth and the sensor is mounted on the throat. The signal acquired by the microphone is processed to extract or obtain the sniffing parameters such as sequences of sniffs with various durations and/or amplitudes and/or duration and/or directions.

In some embodiments, a magnet is attached to the soft palate (such as surgically or by pasting) and a magnetic sensor, positioned, for example, on the face and/or the throat, measures the changes in the magnetic field as the magnet location is changed, thereby determining the position of the palate. The signal acquired by the magnetic field sensor is processed to extract or obtain the sniffing parameters such as sequences of sniffs with various durations and/or amplitudes and/or duration and/or directions.

In some embodiments, a suitably positioned electrical electrode, such as on the scalp akin to EEG data acquisition, is used to acquire the neural activity associated with the soft palate movement, thereby determining the position of the palate by suitable measurements. Optionally the neural activity is measured via a proximity electrode (e.g. antenna) with no contact with the subject. The neural signals acquired by the electrode are processed to extract or obtain the sniffing parameters such as sequences of sniffs with various durations and/or amplitudes and/or duration and/or directions.

At 404, the signal is processed to extract one or more commands. Optionally or alternatively, the processing includes rejecting a background signal and/or noise signals, for example, rejecting breathing signals (e.g., based on them generating very long “sniffs” and/or being part of an ongoing flow of air of, for example, several seconds, such as 5-10 seconds).

In an exemplary embodiment of the invention, the command is a two dimensional command, created by two (or more) independent parameters of the flow, for example, two or more of direction, amplitude and frequency and/or duration

It is noted that amplitude and frequency can be treated as discrete values or as continuous values. For example, a command can include an indication that the amplitude of a next sniff indicates a speed of a wheelchair. In an exemplary embodiment of the invention, at least some of the commands are encoded in Morse code or in a binary code (e.g., short=0 or dot and long=1 or dash)

In some embodiments, sniffing with active (self) respiration provides three degrees of freedom such as by direction (sniff-in/sniff-out), intensity or magnitude (e.g. pressure level) and duration. In some embodiments, another and/or substitute degree of freedom is obtained by amplitude (e.g. envelope) modulation to a plurality of levels (and/or optionally rates of amplitude change).

In some embodiments the sniffs are modulated to 2 levels or more. Optionally, the modulation is based on 3 levels. Optionally, the modulation is based on 4 levels. Optionally, the modulation is based on 5 levels. Optionally, the modulation is based on more than 5 levels.

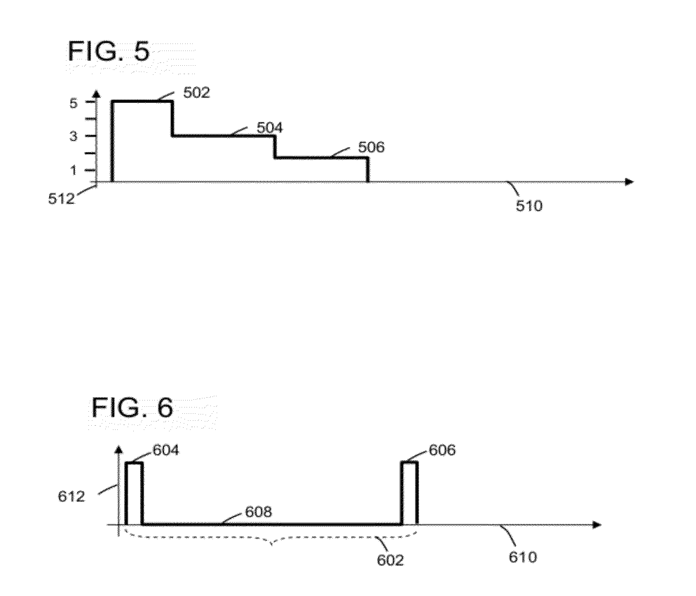

FIG. 5 schematically illustrates a sniffing amplitude modulation along a time axis 510 with respect to amplitude axis 512 arranged in arbitrary relative units 1-5. In the exemplary illustration of FIG. 5 the modulation is made of three decreasing amplitude levels 502, 504 and 506, where the combination of levels, optionally with the durations thereof, provides control data that can be interpreted as a commands and/or commands.

In some embodiments, control information (data) is obtained by sniffing according to a preset pattern, optionally of well known or learned sequence. For example, the opening rhythm of Beethoven's Fifth symphony or other tunes.

In some embodiments, the sniff patterns and/or sequence can be associated with and/or represented as a vector of data elements. For example, a sequence of two short sniffs followed by a sniff of about thrice the representative (e.g. average) of the short sniffs can be represented, for example, as a vector of [1, 1, 3]. As another example, the modulation exemplified in FIG. 5 can be represented as a vector [5, 3, 2].

In some embodiments, the vector comprises elements indicating the magnitude of the sniffs, such as indicating magnitude and duration as a pair of values. For example, a sequence of a sniff of duration ‘D1’ and magnitude ‘M1’ followed by a sniff of duration ‘D2’ and magnitude ‘M2’ is encoded as [(D1, M1), (D2, M2)].

In some embodiments, the vector comprises additional elements for indicating the sniff direction (in or out). For example, a sequence of two short sniffs-out and followed by a sniff-in about four times the short sniffs can be encoded as [−2, 1, 1, −1 4] where preceding negative values indicate the direction of the following elements, such as ‘−2’ for outward direction and ‘−1’ for inward direction.

Optionally, similar to encoding duration and magnitude as described above, the vector is encoded with groups of 3 elements, such as [(O, D1, M1), (I, D2, M2)], where ‘O’ and ‘I’ are codes values for outward and inward sniffs, respectively (e.g. ‘−2’ and ‘−1’ as exemplified above).

Optionally other schemes for indicating the directions can be used, for example, using matrices where each row indicates a particular direction according to a preset arrangement such as first row is inward, second row outward, etc.

Using a vector representation provides, in some embodiments, a unified representation of data, where, optionally, the same vector is obtained using different sniffing schemes. For example, according to the description above, a sequence of sniffs with duration of about 5, 3 and 2 seconds is represented as a vector [5, 3, 2] equivalent to the modulation exemplified in FIG. 5.

In an exemplary embodiment of the invention, the circuitry includes a table indicating a translation between measured values and commands. Optionally, the parsing of commands and/or the table, are context dependent. In an exemplary embodiment of the invention, the command table takes into account the general human ability to have fast (Johnson et al., 2003) and accurate control over their own sniffs (e.g., based on feedback from sensing of airflow in the nostril (Sobel et al., 1998)). Optionally, different tables and/or settings (e.g., pace) are selected for persons with reduced ability (e.g., after stroke, no practice, partial paralysis).

In an exemplary embodiment of the invention, the measured signals are processed to extract one or more of the following parameters (or variations therein) which may be then translated into commands or parameters for such commands: sniff amplitude, flow direction, asymmetry between nostrils, sniff rate and/or sniff envelope shape (e.g., rate of start and/or of end). Optionally or alternatively, non-sniff physiological measurements are collected at the same time and used for command translation. Optionally, these physiological measurements are local to the nostril, including, for example, EMG, changes in facial skin tension, oral cavity pressure, muscle tone, lip movements and/or muscle activation.

It is noted that, in some embodiments of the invention, by separating sniffing from respiration a signal is obtained that has a digital component (“sniff in” vs. “sniff out”) and an analogue component (“sniff vigor”). Combining these two components, can generate a code that allows to control many devices.

In some embodiments, sniff provides both analogue and discrete (e.g. digital) control data. Optionally, the interpretation of the data is governed by a special ‘escape’ (non-data) code that indicates switching between analogue and discrete, e.g. 5 consecutive short sniffs. Optionally or alternatively, special ‘escape’ codes sets the interpretation to either analogue or discrete interpretation, e.g. 5 consecutive short sniff-in and 5 consecutive short sniff-out for analogue and discrete data, respectively.

It is also noted that, in some embodiments, delays between sniffs provide additional operational dimension such as or similar to ‘duty cycle’. For example, a delay time between two short sniffs indicates an analog magnitude, optionally within given boundaries.

For example, a cycle can span about 10 seconds, where a short sniff can last about 1 second and a delay can last between about 3 seconds to about 10 seconds (depending on the respiration capabilities of the subject). Within a breathing (i.e. inhaling or exhaling) a plurality (e.g. 2-3) of duty cycles can be controlled, providing a plurality of commands within a single breath.

FIG. 6 schematically illustrates a sniffing duty cycle 602 along a time axis 610, indicated by dashed bracket 602. Cycle 602 is started by a short sniff 604 and ends with a short sniff 606 with a delay 608 therebetween. The sniff intensity is indicated with respect to an amplitude axis 612.

In some embodiments of the invention, the sniffing data bandwidth (e.g. information rate) as expressed in sniffs sequence or sequences and/or modulation and/or duty cycles and/or frequency is equivalent to about 5 bits/second. Optionally the bandwidth is larger than 5 bits/second, such as about 10 bits/second or about 15 bits/second or about 20 bits/second or any values therebetween or larger then 20 bits/second.

In an exemplary embodiment of the invention, a method of extracting, for example, a sniff duration, is as follows. The voltage indicating pressure in a nostril is continuously tracked. A baseline value is subtracted. When the voltage crosses past a threshold, this indicates the start of a sniff and when it crosses back the threshold or a different threshold, this indicates the end of a sniff. Optionally, different thresholds are defined for inward and outward sniffs. Optionally or alternatively, different thresholds are provided for different sniff strengths (e.g., calibrated to maximum/minimum pressure of sniff or to average sniff strength). In an exemplary embodiment of the invention, the base line is found by calibration (e.g., measurement during a period without sniffs, possibly in response to a user command or periodically). Optionally or alternatively, the baseline is found by continuously tracking an average of nasal air flow rate, optionally ignoring identified sniffs.

In some embodiments, sniffing with assisted (passive) respiration provides two degrees of freedom such as by intensity and duration. In some embodiments, in assisted respiration a pump supplies a low flow (e.g. 3LPM) into a nasal mask having a small hole to exhaust the air when the soft palate is closed, and a pressure sensor measures the mask pressure.

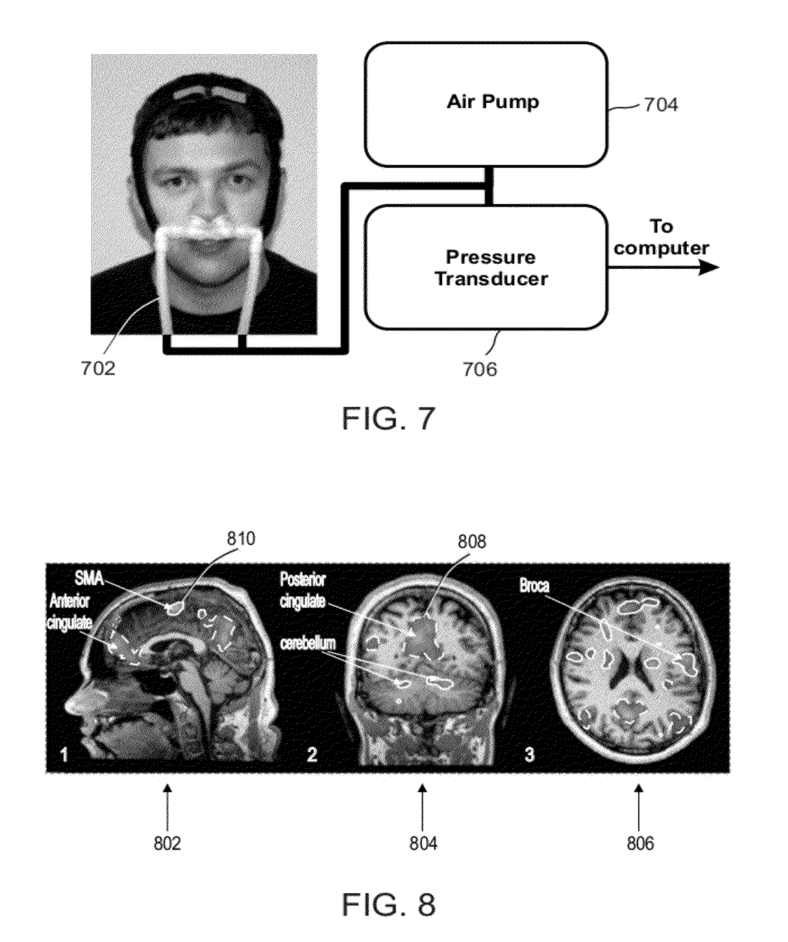

FIG. 7 schematically illustrates a nasal mask 702 disposed on a subject where the outlet thereof (not show) are connected to the nostrils. An air pump 704 supplies air flow to the nostrils through mask 702 and a pressure transducer (sensor) 706 detects pressure variations due to the soft palate motions and/or position, providing sniffing control while the subject respiration is externally controlled or assisted.

In some embodiments, passive respiration provides one degree of freedom as sniff duration only, possibly not sufficiently controlled (no analogue control) since the subject does not control the direction (inhaling and exhaling) nor the flow of respiration and therefore cannot control the amplitude (vigor) of the sniffing.

However, in some embodiments, using the ‘duty cycle’ scheme described above can provide additional freedom by controlling, at least to some extent, the duration of a delay between short sniffs (possibly in any direction, in and/or out).

In some embodiments, determining the position of the palate (e.g. as described above) provides one degree of freedom, such as a spatial direction or an orientation. In some embodiments, changing the position of the palate, particularly according to a pre-set protocol, can provide additional one or more degrees of freedom. For example, consecutive fast changes of the palate position can detected and indicate, for example, switching between X and Y coordinates.

In some embodiments, sniff control is used to provide control in situations where a subject's hands, and optionally legs too, are occupied (or disabled).

For example, in computer games such as flight simulator (e.g. combat planes) the user hands hold a throttle and joystick and sniff control can provide armament control.

In some embodiments sniff control can provide further control to operators such as pilots or seamen (e.g. in submarines) or surgeons operating surgical robots where many operations might be needed to be performed concurrently. For example, the operator's hands manipulate various controls while concurrently sniffing handles other controls.

In an exemplary embodiment of the invention, methods known in the art for straw blowing input are used for sniff input, optionally with modification taking into account the additional commands and flexibility available.

A potential advantage of sniff measurement over gaze control is that gaze control lacks natural sensory feedback. A human has no sensory signal informing us of our direction of gaze independent of foveal vision, and feedback depends either on propreoception, or the actions of the controlled device itself. Optionally or alternatively, sniff control is more robust than gaze control. Such systems depend on accurate optical capture and tracking of the eye. Such optical capture is highly susceptible to interference from anything ranging from internal tremor to external motion. For example, if a paralyzed person is propped in a wheelchair controlled by gaze, and the wheelchair hits a bump in the road, gaze control calibration can be lost. Furthermore, gaze control depends on an expensive, complex, and often fickle combination of optics, electronics, and computing. Some embodiments of the invention lack some or all of these potential disadvantages.

A potential advantage of sniff control over BMI (termed machine-brain interface) is that the level of control that one can gain from pasted electrodes is currently restricted to poor control over a single axis. Furthermore, BMI currently depends on complex stationary and expensive EEG-type recording devices supported by significant computing and data-acquisition powers. In addition, implanted electrodes currently entail a surgical procedure that includes risk, and is not always possible. Some embodiments of the invention lack some or all of these potential disadvantages.

A potential advantage of sniff control over ‘sip-puff’ (e.g. Fugger et al. 2001), is that sniff control can be employed while talking, as well as by subjects with assisted respiration and locked-in subjects.

In some embodiments, sniff control is employed in combination with ‘sip-puff’ or similar breathing methods, providing further degrees of freedom. For example, in controlling an electric wheelchair ‘sip-puff’ is used for forward-backward movements while sniff control is used for turning, accelerating/decelerating or stopping.

Referring back to FIG. 4, at 406, a device is optionally controlled and/or the command is sent as input to a computer program.

At 408, feedback is optionally provided to a user, for example, visually, by sound or tactile input or to the nostril.

A potential advantage of sniff control is that some sniffing events are not directly under conscious control. In an exemplary embodiment of the invention, a system can track both conscious and less conscious instructions/input from a user.

### Exemplary Controlled Devices

Substantially any device that receives input can be usefully controlled by sniffing. In particular, as noted above, devices that respond quickly and/or accurately can benefit from the fast and/or accurate control many people have over their sniffing ability.

Exemplary devices include: wheelchairs, computer software and cursor control, robots, artificial limbs, musical instruments, manipulators, triggering devices, communication devices, security or biometric mechanism, electrification (or other stimulation) of natural but paralyzed limbs, machine components and/or devices needed for paralyzed persons, such as a respirator. In an exemplary embodiment of the invention, the device controlled is autonomous to the user, for example, being a data logger, an air sampler or another device whose output is not immediately (e.g., within a few seconds, such as 1, 5, 10, 15 or less) noticeable to the user. A specific example is a system in which a camera mask and/or user goggles are unmasked (e.g., by controlling an LCA (liquid crystal array) or other polarization modifying element which otherwise cooperates with a fixed polarizer in the goggles, or a different type of light shutter) responsive to a user sniffing.

In an exemplary embodiment of the invention, the sniff controller is used for providing communication needs, such as indicating the want of food or drink, indication of the feeling of pain and/or detailing of thoughts (e.g., instead of talking, for example, using a voice synthesizer driven by sniffing).

In an exemplary embodiment of the invention, the sniff controller is used for applications ranging in complexity from a simple on-off mechanism such as an alarm, and onto more complicated machinery such as an electric wheel chair, and culminating in complex bimanual machinery such as a crop-duster airplane.

In an exemplary embodiment of the invention, the sniff controller serves as an input for a communication device, for example, a cellular telephone (e.g., to answer or dial or send text or other messages) or a computer feed (e.g., to the user), such as e-mail or a search engine. In an exemplary embodiment of the invention, the nasal element includes a microphone and/or a speaker. The computer and/or cellular telephone circuitry may be, for example, connected by wired or wireless means and/or be integrated into the nasal piece.

In an exemplary embodiment of the invention, the system is used as a measure of brain plasticity, for example, by measuring a change in connections between a olfactory region in the brain and another sensory region, wherein the system is set up so as to gate or modulate the perception of the other sensing modality in response to sensing. Optionally or alternatively, the system is used to encourage plasticity in the brain, for example, in a stroke victim where sniffing is used to generate a stimulation of sensory modulation to a patient. Optionally or alternatively, the system is used as a laboratory (or other) test of the effectiveness of plasticity modifying treatments, such as drugs, by testing changes in brain plasticity with and without a treatment.

In order to study the brain response to soft palate control, an fMRI scan was obtained by employing a block-design paradigm alternating between blocks of volitional soft-palate control (VC) and an oral breathing baseline. During 6 blocks, each lasting about 28 seconds, an auditory cue (“open/close”) instructed subjects to open and then close their soft palate seven times within a block (a soft-palate akin to a conventional finger-tapping task). Real-time spirometry verified soft-palate closure. During the control blocks, a meaningless auditory cue (“one/two”) was sounded to equate for auditory stimulation.

FIG. 8 illustrates an fMRI scan of brain activation during volitional control of the soft palate by a subject, in mid-sagital, coronal and transverse sections, as indicated by arrows 802, 804 and 806, respectively.

The bold contours 810 indicate high activation of brains regions, and the dashed contours 808 indicate somewhat lower activation.

As FIG. 8 demonstrate, sniffing by controlling the soft palate involves several regions of the brain illustrating how the brain employs various functional regions in controlling the soft palate.

While the application has focused on human users, also non-human users can be trained to use a sniff system. For example, a dog can have his sniffing monitored remotely to indicate suspicious smells and/or a dog can be trained to sniff in a certain way to call for help instead of barking.

In an exemplary embodiment of the invention, system 100 includes a smell analyzer, for example, a mass spectrometer or gas spectrometer (not shown) which collects air from the nostril or other location (e.g., via tube 116) and which generates a signal indicative of certain smell molecules and may be used to provide feedback to a user and/or to modify a meaning of a command.

As noted above, different people have different sniff control abilities. In particular, there are two classes of persons which may be of interest, and for which different settings may be useful:

(a) individuals who are able to volitionally switch between nasal and oral breathing (VC), without closing of the mouth; and

(b) individuals who are not able to volitionally induce this transition.

It should be noted in this context, that self respiration is a well-preserved faculty. In other words, many patients may have completely paralyzed limbs, yet be able to self respirate. It should be noted that the sniff-controller may be functional in non-self-respirating individuals as well.

It is expected that nearly all healthy individuals, nearly all amputees, and a good proportion of largely paralyzed individuals, will be able to gain good VC. An exemplary training method is described below.

VC is central to some embodiments of the invention because it enables dissociating respiration from sniffing. In other words, the sniff-controller uses sniffs to control devices, not respiration. It should be noted that the device may also be usable in non-self respirating individuals which can learn VC. For example, a respirator would generate the airflow, and the patient would use VC to redirect this airflow to the nose or mouth, thus driving the device. In patients that cannot learn VC, control of the lips may allow some control over nasal flow.

Some specific implementation examples:

### Example 1

### Using the Sniff-Controller to Communicate (A)

The nasal tube is linked to the transducer that drives a “Morse code” decoder. A short inward sniff is a “dot”, a long inward sniff is a “line”, and an outward sniff is a separator between words. The output can be directed to a text monitor, a digital speech generator, or both.

### Example 2

### Using the Sniff-Controller to Communicate (B)

The nasal tube is linked to a transducer that drives a cursor on a computer screen. The screen contains a “text-board”, with letters in rows and columns. Sniffing “in” runs the courser along the column, and then sniffing “out” runs the courser along the rows. Sniff-vigor determines the speed of the courser motion. Once a letter is reached the courser blinks, and if it is not moved for a few seconds, that letter is selected. The system optionally uses existing word-completion algorithms based on word frequency in order to accelerate the writing process.

### Example 3

### Using the Sniff-Controller to Emulate a Mouse (A)

The nasal tube is linked to a transducer that drives a cursor on a computer screen in Cartesian or polar (r, θ) coordinates, emulating a mouse or equivalents thereof.

It is emphasized that the ubiquitous mouse and operation thereof are used herein also to represent, mutatis mutandis, controlling any device in terms of analogue data (e.g. spatial or planer direction and/or magnitude and/or speed and/or acceleration) and/or discrete events or actions (e.g. clicks).

An exemplary emulation is as follows:

A first long sniff indicates a movement in the first coordinate (X or θ) responsive to the sniff intensity where the sniff direction indicates the polarity (positive or negative).

A second long sniff indicates a movement in the second coordinate (Y or r) responsive to the sniff intensity where the sniff direction indicates the polarity.

Two successive short sniffs indicate a click (in-then-out for left click, and out-then-in for right click).

Starting of a sequence is indicated by two successive short sniff-in, and consecutive long sniffs are handled in a round-robin manner (as first, second, first, etc.).

Selection of Cartesian or polar coordinates is indicated by three consecutive short sniff-in and three short sniff-out, respectively.

### Example 4

### Using the Sniff-Controller to Emulate a Mouse (B)

Similar to the mouse emulation above (Example 3), an accelerated operation mode of mouse emulation in polar (r, θ) coordinates is as follows:

Long sniff-in indicated movement in θ (rotation) in one direction with wrap-around until stopped (e.g. in CCW direction). In some embodiments, feedback is provided such as by displaying arrows indicating the motion and/or auditory notifications.

Long sniff-out indicates movement in r in one direction with wrap-around so that when the cursor reaches a boundary of the screen the motion is continued from the opposite boundary.

Two successive short sniffs indicate a click (in-then-out for left click, and out-then-in for right click).

### Example 5

### Using the Sniff-Controller to Emulate a Mouse (C)

Similar to the mouse emulations above (Examples 3 and 4), mouse emulation using ‘duty cycle’ coding can provide sniffing control in cases of respiration difficulties or with assisted respiration.

An exemplary emulation in polar (r, θ) coordinates is as follows: A first ‘long sniff’, i.e. short sniff with long delay (e.g. over 2 seconds) till a subsequent short sniff indicates movement in θ (rotation) in one direction responsive to the delay (e.g. proportional or non-linear relation).

A second ‘long sniff’, i.e. short sniff with long delay till a subsequent short sniff indicates movement in r in one direction responsive (e.g. proportional) to the delay.

A subsequent short sniff as above can indicate the beginning of a next duty cycle.

A short delay (e.g. less than 2 seconds) followed by a long delay indicates movements with reversed polarity relative to a previous movement.

Two successive short sniffs indicate a left click, and three successive short sniffs indicate a right click.

### Example 6

### Using the Sniff-Controller to Emulate a Mouse (D)

Similar to the mouse emulations above (Examples 3 and 4), mouse emulation using cycling controls can provide sniffing control in cases of respiration difficulties or with assisted respiration.

In a small window (relative to the screen) six tabs (e.g. rectangles or circles), designating the four cursor motion directions (Cartesian and polar coordinates) and the two mouse buttons, are highlighted in a loop-wise manner with a predetermined time interval (‘scanning’). An action (cursor motion or button click) is selected and activated when the user “sniffs” at a required tab operation while active (highlighted).

In case a cursor motion is selected, the tab remains active while the cursor is moving in the respective direction in a predetermined rate, and the motion stops when the user “sniffs”. After the cursor stops, the interface resumes scanning the six tabs as described above.

### Example 7

### Using the Sniff-Controller Akin to Mouse Operation

As noted above, the mouse operation represents controlling other devices in terms of analogue data and/or discrete events or actions, optionally with more than two directions and/or two or three actions of a mouse.

Exemplary devices comprise, without limiting, robots, artificial limbs, feeding devices, vehicle mounting and/or dismounting devices, driving mechanisms, entertainment devices (e.g. television, DVD, sound equipment), navigation devices, devices for objects picking and operation (e.g. picking a book from a shelf or table and/or flipping pages), lighting devices, games operations (e.g. chess or checkers or backgammon optionally including dice rolling) or computer or video games, and other devices with analogue and/or discrete control.

Typically, in some embodiments, the sniffing control interfaces with a device by suitable apparatus that operates the device according to the sniffing control. Optionally the interface is operated via wire or wires and/or via a wireless link. For example, a particular interface links between the sniffing control and control operation of a DVD.

### Example 8

### Using the Sniff-Controller to Drive an Electric Wheelchair

The nasal tube is linked to the transducer that drives the chair motors. Optionally, the transducer contains a processor that combines sniffs over a time-window. For example; two consecutive low-magnitude “in” sniffs start forward motion. Then, a shallow “in” sniffs turn right, and shallow “out” sniffs turn left. A strong “in” sniff causes a stop. Similarly, two consecutive low-magnitude “out” sniffs start backward motion. Turning and stopping rules can remain the same as in the forward condition.

### VC Control and Training

As noted above, volitional switching between nasal and oral breathing without mouth closure is useful for using some of the methods described, and is typically obtained by velopharyngeal closure (VC). VC is the apposition of the palate to the upper posterior pharyngeal wall as in deglutition and in some speech sounds. VC, i.e., switching between nasal and oral breathing without mouth closure, is easily generated by some individuals but not by others. Some persons may have other ways of modulating the airflow to/from the nasal cavities and such ways may also be used and/or trained for.

In an exemplary embodiment of the invention, device utilization is improved by training user to apply VC. Optionally, the training is built into the device.

In an exemplary embodiment of the invention, the VC Trainer includes the sensor tube in the nose, and a second sensor tube placed at the entrance to the mouth. Optionally, each tube is transduced separately. Alternatively a differential sensing is used, optionally using a single tube with openings into nose and mouth, but may result in less accurate training and/or be improved by a sensor of aspiration and/or inspiration (such as a chest band). The output is directed to a computer that is linked to a monitor in front of the participant (patient or healthy individual), or another output device, such as a speaker. The training software instructs the participant via text on the monitor (or audio instructions) whether they are to breath orally or nasally. The system compares the input from the two tubes, and determines a success at following the given instruction. The success is optionally conveyed to the participant in a form of an image of a flame that the participant is to “put out”. For example, if the instruction is to “Breath orally”, yet the system measures nasal pressure, a large flame is displayed on the monitor. This flame is reduced as a function of reduction in nasal pressure (which oral pressure that continues or increases, to indicate airflow is occurring). If the instruction is to “Breath nasally”, yet the system measures oral pressure, a large flame is also displayed on the monitor. This flame is reduced as a function of reduction in oral pressure (and increase or maintenance of nasal pressure). This graphic interface can provide a simple and intuitive training tool, e.g. by interactively adjusting the breathing switching. Optionally, initial training will consist of transitions from two minutes nasal breathing to two minutes oral breathing, and will continue with more complex patterns of breath-by-breath alternations between nasal and oral respiration. Other feedbacks can be used as well.

### Exemplary Performance of a Sniff Control Relative to a Mouse and a Joystick

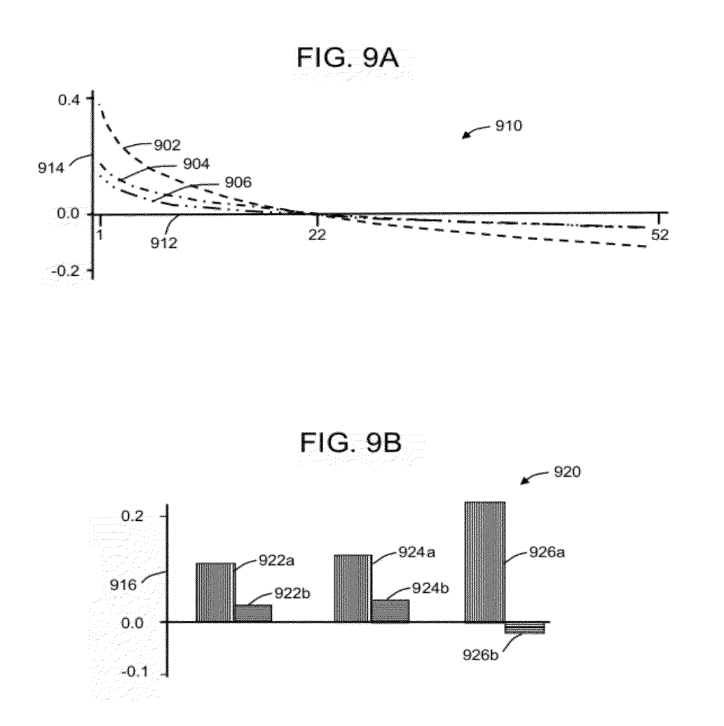

FIG. 9A schematically illustrates in a chart 910 experimental reaction time to an interactive stimulus with respect to training time with a mouse, joystick and sniff controller, in accordance with exemplary embodiments of the invention.

A stimulus was shown on screen and subjects used an ordinary mouse, an ordinary joystick and a sniff control according to some embodiments of the invention, to react to the stimulus. In some embodiments, the stimulus was a circle on a computer screen that changes color at random time within a certain range (e.g. 5±1 second), and the subjects had to react upon a color change. In some embodiments, the circle was stationary on the screen and in some embodiments, the circle moved randomly across the screen.

Chart 910 illustrates experimental results in normalized units 914 (shifted for a common axis) with respect to time axis 912 in seconds. Dashed curve 902 illustrates the reaction time for the sniff controller, dash-dot curve 904 illustrates the reaction time for a joystick and dash-dot-dot curve 906 illustrates the reaction time for a mouse.

As persons typically adapt or are used to the intuitive operation of a mouse and joystick, the respective initial reaction time for a mouse and joystick was smaller relative to the seemingly non-intuitive operation of sniffing.

However, after about 22 seconds the reaction time for the sniff controller became smaller relative to the mouse and joystick operation which approximately coincided.

FIG. 9B schematically illustrates a chart 920 summarizing experimental reaction times to an interactive stimulus before and after training with a mouse, joystick and sniff controller, in accordance with exemplary embodiments of the invention.

Similar to chart 910 of FIG. 9A, chart 920 shows in normalized units initial and trained reaction times of a mouse (922a and 922b, respectively), of a joystick (924a and 924b, respectively) and sniff controller (926a and 926b, respectively).

According to charts 910 and 920 it can be plausibly concluded that after some training sniffing, which does not require hand motion, can achieve temporal performance as good as or better than the operation of conventional interaction devices such as mouse and joystick. Charts 910 and 920 also indicate that the mechanism of sniffing detection and interpretation can be sufficiently fast compared to operation of a mouse or joystick.

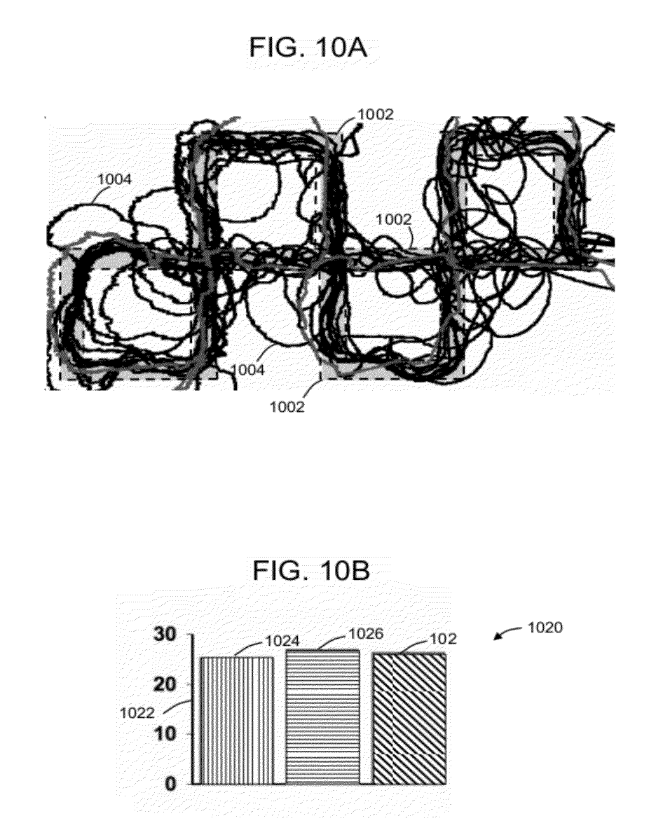

FIG. 10A schematically illustrates experimental results of accuracy of tracking a guide pattern 1002 with a mouse, joystick and sniff controller, in accordance with exemplary embodiments of the invention. The tracings 1004 of the mouse, joystick and sniff controller are similar and with black rendering are practically indistinguishable.

FIG. 10B schematically illustrates in a chart 1020 a summary of experimental accuracies as average distance in pixels (axis 1022) of tracking a guide pattern on a screen with a mouse (1024), joystick (1026) and sniff controller (1028), in accordance with exemplary embodiments of the invention.

According to FIG. 10A and chart 1020 of FIG. 10B it can be plausibly concluded that the tracking performance (control vs. visual guidance) of sniffing is at least generally or averagely as accurate as the tracking performance of conventional interaction devices such as mouse and joystick.

Thus, according to the data presented in FIGS. 9A-10B, sniffing with the associated detection thereof can provide, at least in some embodiments, rapid and accurate operation (e.g. control) comparable to conventional manual apparatus.

### Potential Benefits

Some potential advantages and benefits of some embodiments of the invention, one or more of which may be realized, include:
   Rapid response time, comparable to and/or faster (at least after some training) than conventional intuitive devices such as a mouse or joystick.
   Tracking accuracy comparable to conventional intuitive devices such as a mouse or joystick.
   Wearable apparatus, optionally as a miniature device disposed about the nose.
   As a wearable apparatus some embodiments of sniff control can be contrasted with ‘sip-puff’ or similar devices where the subject has to get an air-tight grip of an external device.
   Remote sensing of the palate position, optionally as a passive device such as a microphone.
   As a remote sensing apparatus some embodiments of sniff control can be contrasted with ‘sip-puff’ or similar devices where the subject has to actively get an air-tight grip of an external device.
   Analogue and discrete control.
   Wireless communication, avoiding wires.
   Self generation of power from body heat and/or motions.
   Operable by subjects with assisted and/or passive respiration (artificial respiration, non-self-respiration).
   It should be noted that in at least many cases ‘sip-puff’ operation or other methods based on breathing are not feasible with passive respiration since the subject has to actively control the inhaling and exhaling of air.
   Operable by ‘locked-in’ subjects.
   It should be noted that in at least many cases ‘sip-puff’ operation or other methods based on moving and/or firmly holding control element are not feasible with ‘locked-in’ subjects since ‘locked-in’ subjects cannot move the head and/or firmly hold a device tightly.
   Simultaneous and/or interleaved control and talking.
   It should be noted that in at least many cases ‘sip-puff’ operation or other methods based on breathing are not feasible for simultaneously talk and control since the subject has to actively control the inhaling and exhaling which generally prevents concurrent talking.

### General

It is expected that during the life of a patent maturing from this application many relevant sensors will be developed and the scope of the term air property sensor is intended to include all such new technologies a priori.

As used herein the term “about” refers to ±10%

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of receiving input from a user, comprising:
(a) measuring a nasal sniff parameter; and
(b) generating an instruction for one or both of a device and controller based on said measurement.

2. A method according to claim 1, wherein said measuring comprises measuring at least two independent parameters of said nasal sniff, and generating an instruction therefrom.

3. A method according to claim 1, wherein said measuring comprises measuring at least three independent parameters of said nasal sniff, and generating an instruction therefrom.

4. A method according to claim 1, wherein said measuring comprises measuring at least one analogue parameter, and generating an instruction therefrom.

5. A method according to claim 1, wherein said measuring comprises measuring at least one of air direction, air flow duration, air pressure, air flow rate or sound frequency, and generating an instruction therefrom.

6. A method according to claim 1, wherein said measuring comprises measuring any combination of air direction, air flow duration, air pressure and air flow rate, or sound frequency, and generating an instruction therefrom.

7. A method according to claim 1, wherein said generating comprises generating responsive to duty cycle of air flow parameter.

8. A method according to claim 1, wherein said generating comprises generating a vector representative of the command.

9. A method according to claim 1, wherein said generating comprises generating using a table.

10. A method according to claim 1, wherein said generating comprises generating using a series of measured parameter values.

11. A method according to claim 1, wherein generating an instruction for one or both of a device and controller comprises providing a feedback for the instruction from the one or both of a device and controller.

12. A method according to claim 1, wherein said measuring comprises measuring form two nostrils.

13. A method according to claim 1, comprising training a user in selectively directing airflow to the nasal area.

14. A method according to claim 1, wherein said user is paralyzed in at least four limbs.

15. A method according to claim 1, wherein said user is artificially respirated.

16. A method according to claim 1, wherein said user is not handicapped.

17. A method according to claim 1, wherein receiving input from a user comprises deciding an operation for one or both of a device and controller, expressing the decision by at least one nasal sniff and generating an instruction for the one or both of a device and controller based on measuring the sniff.

18. A method of receiving input from a user, comprising:
(a) deciding an operation for one or both of a device and controller;
(b) expressing the decision by at least one nasal sniff; and
(c) generating an instruction for the one or both of a device and controller based on the sniff.

19. A method according to claim 18, wherein expressing the decision by at least one nasal sniff comprises expressing the decision in a sequence of a plurality of sniffs.

20. Apparatus for control, comprising:
(a) a sensor configured to measure a nasal sniff parameter; and
(b) circuitry which converts said measurement into a command for one or both of a device and a controller.

21. Apparatus according to claim 20, comprising a sensor for each nostril.

22. Apparatus according to claim 20, wherein said circuitry differentiates inwards sniffing from outwards sniffing.

23. Apparatus according to claim 20, wherein said circuitry ignores natural breathing.

24. Apparatus according to claim 20, wherein said device comprises a device controlled electrically or electronically or programmatically or by any combination thereof.

25. Apparatus according to claim 20, wherein said device comprises a device having one or both of analogue or discrete control.

26. Apparatus according to claim 20, wherein said device comprises a pointing device on a computer driven display.

27. Apparatus according to claim 20, wherein said device comprises a wheelchair.

28. Apparatus according to claim 20, wherein said controller comprises a communication device.

29. A method of receiving input from a subject, comprising:
(a) assessing the position of the soft palate of the subject; and
(b) generating an instruction for one or both of a device and controller based on the assessment of the position of the soft palate.

30. A method according to claim 29, wherein the assessment is responsive to a reflection of a sound wave transmitted towards the soft palate.

31. A method according to claim 29, wherein the assessment is responsive to magnetic field of a magnet attached to the soft palate.

32. A method according to claim 29, wherein the assessment is responsive to a neural activity acquired by an electrode.

33. A method according to claim 29, wherein assessing the position of the soft palate is responsive to sniffing by the subject.

34. A method according to claim 29, wherein the subject is artificially respirated.

35. An apparatus for control, comprising:
(a) a sensor configured to assess the position of the soft palate of the subject; and
(b) circuitry for generating an instruction for one or both of a device and controller based on the assessment of the position of the soft palate.

36. A method for training a subject to switch between a nasal and oral breathing without mouth closure, comprising:
(a) providing an air passage to the nose and an air passage to the mouth of the subject;
(b) measuring the air flow in said passages responsive to prompting the subject to breath orally or nasally; and
(c) providing the subject with a feedback on the success of switching between a nasal and oral breathing.

37. A method according to claim 36, wherein the success of switching is presented graphically, enabling the subject to interactively adjust the switching.

38. A method according to claim 1, wherein measuring a nasal sniff parameter comprises measuring at least one nasal inward sniff parameter.

39. A method according to claim 1, wherein measuring a nasal sniff parameter comprises measuring at least one nasal outward sniff parameter.

40. A method according to claim 18, wherein expressing the decision by at least one nasal sniff comprises expressing the decision by at least one nasal inward sniff parameter.

41. A method according to claim 18, wherein expressing the decision by at least one nasal sniff comprises expressing the decision by at least one nasal outward sniff parameter.

42. Apparatus according to claim 20, wherein said sensor is configured to measure a nasal inward sniff parameter.

43. Apparatus according to claim 20, wherein said sensor is configured to measure a nasal outward sniff parameter.
